(19) United States
(12) Patent Application Publication
(10) Pub. No.: US 2002/0078274 A1
(43) Pub. Date: Jun. 20, 2002

(54) Electronic apparatus having hub function

(76) Inventors: Ken Kutaragi, Kanagawa (JP); Mariko Hino, Kanagawa-ku (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/993,097

(22) Filed: Nov. 6, 2001

(30) Foreign Application Priority Data
Nov. 7, 2000 (JP) 2000-339684
Oct. 19, 2001 (JP) 2001-322793

(51) Int. Cl. G06F 13/10; G06F 13/12; G06F 13/38

(52) U.S. Cl. 710/62

(57) ABSTRACT

A display apparatus includes a hub and one or a plurality of connectors. Electronic devices are connected to the connectors. A computer is electrically connected to the hub. The computer is connected to the display apparatus through the hub. Information is supplied from the computer to the electronic devices and from the electronic devices to the computer through the hub, thus avoiding the complexity of connecting devices when a USB is used.

### CROSS REFERENCE TO RELATED APPLICATIONS

The present application claims priority from Japanese Application Nos. 2000-339684 filed Nov. 7, 2000 and 2001-322793 filed Oct. 19, 2001, the disclosures of which are hereby incorporated by reference herein.

### BACKGROUND OF THE INVENTION

The present invention relates to an electronic apparatus such as a display apparatus having a function as a USB (Universal Serial Bus) hub, an electronic device capable of being attached thereto, and an external apparatus including them.

Hitherto, a USB hub itself has been known. However, there is no electronic apparatus serving as a USB hub.

### SUMMARY OF THE INVENTION

It is an object of the present invention to provide an electronic apparatus used as both an electronic apparatus and a USB hub.

According to the present invention, there is provided an electronic apparatus, including a main body; a circuit in the main body functioning as a hub; at least one first connector portion electrically connected to the circuit; and an electronic device connected to the at least one first connector portion, wherein a computer is connectable to the electronic apparatus through the circuit so that information from the computer is supplied to the electronic device and/or information from the electronic device is supplied to the computer.

In the electronic apparatus, power may be supplied from the circuit to the electronic device, or power may be supplied from the computer to the electronic device via the circuit.

Preferably, the electronic apparatus is a display apparatus.

According to the present invention, there is also provided an external apparatus, including an electronic apparatus having a main body, a circuit in the main body functioning as a hub, and at least one first connector portion electrically connected to the circuit; an electronic device connected to the electronic apparatus; and a computer connected to the electronic apparatus via the circuit for transmitting information to and receiving information from the electronic device.

According to the present invention, there is further provided an electronic device capable of being attached to an electronic apparatus having a main body, a circuit in the main body functioning as a hub, and at least one first connector portion integrally formed in the main body and electrically connected to the circuit, the electronic device including a body; an operating portion in the body; and a second connector portion integrally fixed to the body and adapted for connection to the at least one first connection portion, wherein the electronic device can be directly attached to the main body of the electronic apparatus and can transmit information to or receive information from a computer connected to the electronic apparatus through the circuit.

### BRIEF DESCRIPTION OF THE DRAWINGS

FIG. 1 is an explanatory diagram showing a display apparatus as an example of an electronic apparatus according to the present invention and electronic devices connected thereto;

FIG. 2 is an explanatory diagram showing the display apparatus as an example of the electronic apparatus according to the present invention and the electronic devices connected thereto; and

FIG. 3 is a block diagram showing the display apparatus as an example of the electronic apparatus according to the present invention, electronic devices connected thereto, and a computer connected to the display apparatus.

### DETAILED DESCRIPTION

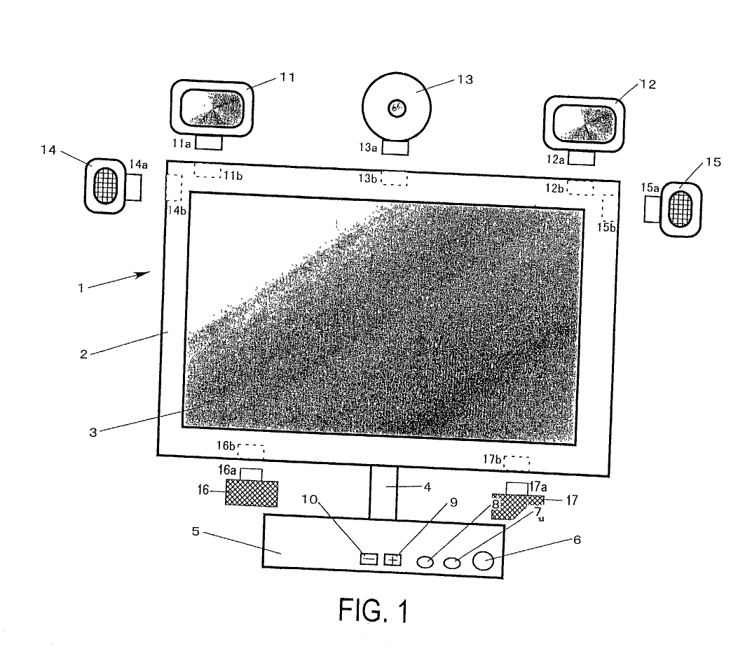

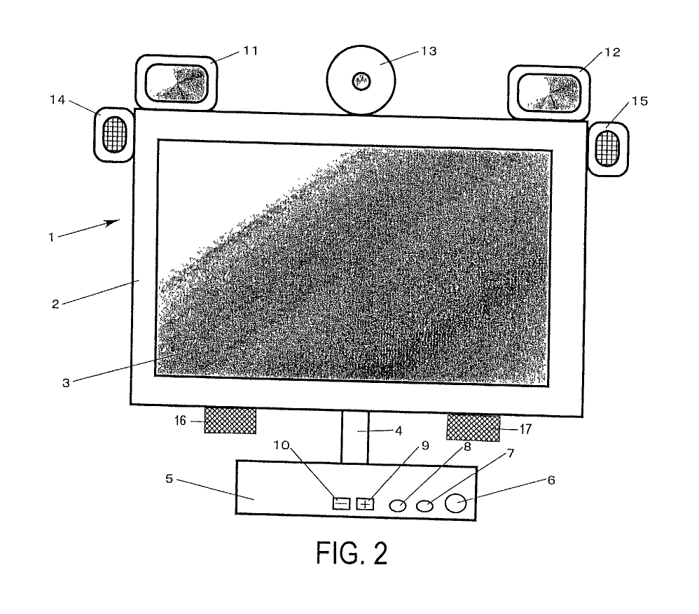

As shown in FIGS. 1 and 2, according to an embodiment of the present invention, a plurality of electronic devices 11, 12, 13, 14, 15, 16, and 17 are connected to a display apparatus 1 such as an LCD (Liquid Crystal Display).

The display apparatus 1 has USB connectors (female connectors) 11b, 12b, 13b, 14b, 15b, 16b, and 17b, namely, seven connectors in total. Referring to FIG. 1, the USB connectors 11b to 17b are arranged in a frame 2 of the display apparatus 1. In other words, the connectors lib to 17b are integrally provided for (or mounted in) a supporting member for supporting a liquid crystal display as a screen.

The USB connector 11b is arranged at the left end in the upper portion of the display apparatus 1, the USB connector 12b is arranged at the right end in the upper portion of the display apparatus 1, the USB connector 13b is arranged at the center in the upper portion of the display apparatus 1, the USB connector 14b is arranged in the upper portion on the left side surface of the display apparatus 1, the USB connector 15b is arranged in the upper portion on the right side surface of the display apparatus 1, the USB connector 16b is arranged on the left side in the bottom of the display apparatus 1, and the USB connector 17b is arranged on the right side in the bottom of the display apparatus 1.

As will be described hereinbelow, the USB connectors 11b to 17b are positioned so that the electronic devices 11 to 17 attached to these connectors 11b to 17b are arranged at the optimum positions for the user (viewer) of the display apparatus 1. For example, when the electronic devices 11 to 17 are a camera, a speaker, a microphone, and the like, the electronic devices 11 to 17 are disposed so as to face the user of the display apparatus 1. Furthermore, when the electronic devices 11 to 17 input or output stereoscopic images or sounds, the electronic devices 11 to 17 are arranged at balanced positions with respect to the user of the display apparatus 1 on the right and left sides.

Referring to FIG. 1, the first and second video cameras 11 and 12, infrared camera 13, left and right microphones 14 and 15, and left and right speakers 16 and 17 are directly connected to the connectors 11b, 12b, 13b, 14b, 15b, 16b, and 17b through USB connectors (male connectors) 11a, 12a, 13a, 14a, 15a, 16a, and 17a, respectively. Referring to FIG. 2, the connection creates a display apparatus having a camera function, a microphone function, an infrared camera function, and speakers.

The connectors 11a to 17a are connected to the electronic devices 11 to 17 without a cable. They are directly fixed to the electronic devices 11 to 17. Namely, the connectors 11a to 17a are integrally provided for the electronic devices 11 to 17, respectively.

Alternatively, the display apparatus 1 may include male connectors and the video cameras, infrared camera, microphones, and speakers may include female connectors.

Referring to FIGS. 1 and 2, in the display apparatus 1, an LCD 3 is held by the frame 2. The frame 2 is connected to a base 5 through a support 4. A power switch 6, a brightness control switch 7, a contrast control switch 8, an increment button 9, and a decrement button 10 are provided for the display apparatus 1. The user presses the brightness control switch 7 and then presses the increment button 9 or decrement button 10, so that he or she can adjust the brightness. Similarly, the user presses the contrast control switch 8 and then presses the increment button 9 or decrement button 10, so that he or she can adjust the contrast.

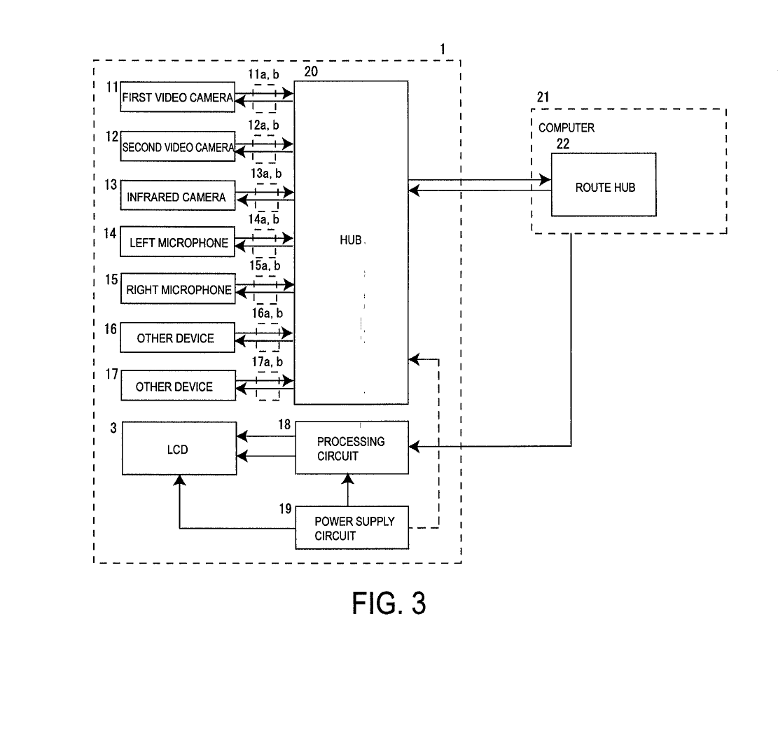

The display apparatus 1 and the electronic devices 11 to 17 shown in FIGS. 1 and 2 and a computer 21 connected to the display apparatus 1 will now be described with reference to FIG. 3.

Referring to FIG. 3, the display apparatus 1 is connected to the computer 21. In other words, a video output of the computer 21 is supplied to a processing circuit 18 of the display apparatus 1. A route hub 22 of the computer 21 is connected to a hub 20 of the display apparatus 1 according to a connecting method based on the USB specification. That is, the connectors and hubs are constructed on the basis of the USB specification.

Power may be supplied from the route hub 22 to the hub 20 or may be supplied from a power supply circuit 19 of the display apparatus 1 to the hub 20.

The first and second video cameras 11 and 12 face the user of the display apparatus 1 and they are arranged at balanced positions with respect to the user on the left and right sides. The cameras are arranged in this manner so that they can capture a stereoscopic image (picture) of the user. Power is supplied from the hub 20 to the first and second video cameras 11 and 12. Outputs of the first and second video cameras 11 and 12 are supplied to the computer 21 via the hub 20 and the route hub 22 and are then subjected to a process. After that, the outputs are displayed on the LCD 3 through the processing circuit 18.

The infrared camera 13 is arranged so as to face the user so that the camera can capture an image of the user of the display apparatus 1 or detect the position of the user. Power is supplied from the hub 20 to the infrared camera 13. An output of the infrared camera 13 is supplied to the computer 21 through the hub 20 and the route hub 22. The output is subjected to a process and, after that, the output is displayed on the LCD 3 via the processing circuit 18.

The left and right microphones 14 and 15 face the user of the display apparatus 1 and are arranged at balanced positions with respect to the user on the left and right sides. The voice of the user can be stereophonically captured by arranging the speakers in this manner. Power is supplied from the hub 20 to the left and right microphones 14 and 15. Outputs of the left and right microphones 14 and 15 are supplied to the computer 21 via the hub 20 and the route hub 22. The outputs are subjected to a process and, after that, they are generated as sounds from the left and right speakers 16 and 17 through the hub 20. The paths are shown as examples. It is needless to say that the outputs may be generated from a device connected to the computer 21.

The left and right speakers 16 and 17 face the user of the display apparatus 1 and are arranged at balanced positions with respect to the user on the left and right sides. Stereophonic sounds can be provided to the user by arranging the speakers in this manner. Power is supplied from the hub 20 to the left and right speakers 16 and 17. Audio signals supplied via the hub 20 are generated as sounds from the left and right speakers 16 and 17.

As mentioned above, according to the present embodiment, the hub function is added to the display apparatus. As compared with a case where a hub is separately used, the case according to the present embodiment is not complicated. The electronic devices 11 to 17 can be directly connected to the display apparatus 1. Each electronic device is integrated with a connector. Accordingly, as compared with a case where a USB connector is connected to each electronic device via a code, the electronic device with the connector can be connected to the display apparatus 1 as a part thereof. Consequently, wiring becomes invisible, so that the appearance is improved. Furthermore, when the connectors are connected to each other, the setting is completed. Accordingly, it is not troublesome.

Since the connectors 11b to 17b on the display apparatus 1 side are provided in the desired positions in the display apparatus 1, the positional relationship between the electronic devices 11 to 17 and the user of the display apparatus 1 can be optimized simply by connecting the male and female connectors with each other. Furthermore, since the connectors 11b to 17b are provided in the frame 2 of the display apparatus 1, the positional relationship between the user viewing the screen of the display apparatus 1 and the electronic devices 11 to 17 can be easily set. For example, the electronic devices 11 to 17 can be attached so as to face the user.

In both the case where power is supplied from the power supply circuit 19 of the display apparatus 1 to the hub 20 or the case where power is supplied from the route hub 22 of the computer to the hub 20, it is unnecessary to arrange a power supply circuit used only for the hub or to provide an AC adapter, so that the peripheries of the devices are not complicated.

In the present embodiment, the display apparatus has been explained as an example. The hub function may also be built in another electronic apparatus such as a printer or a scanner. Electronic devices other than devices 11 to 17 can be used. Each of the electronic devices 11 to 17 may also be used as a hub.

It is needless to say that the present invention can be applied to not only the USB but also any bus having a form similar to the USB. For example, a LAN (Local Area Network) can be considered.

As mentioned above, according to the present invention, since the hub function is applied to the electronic apparatus, the peripheries of the devices are not complicated. Since each connector is directly connected to each electronic device, the setting upon connecting to the electronic apparatus is not needed and the electronic devices can be visually integrated with the electronic apparatus.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An electronic apparatus, comprising:
a main body;
a circuit in the main body functioning as a hub;
at least one first connector portion electrically connected to the circuit; and
an electronic device connected to the at least one first connector portion,
wherein a computer is connectable to the electronic apparatus through the circuit so that information from the computer is supplied to the electronic device and/or information from the electronic device is supplied to the computer.

2. An apparatus according to claim 1, wherein power is supplied from the circuit to the electronic device.

3. An apparatus according to claim 1, wherein power is supplied from the computer to the electronic device via the circuit.

4. An apparatus according to claim 1, wherein the electronic apparatus is a display apparatus.

5. An apparatus according to claim 1, wherein the electronic device has a second connector portion directly fixed thereto and the at least one first connector portion is integrally formed in the main body, the second connector portion being connected to the at least one first connector portion to directly attach the electronic device to the main body.

6. An apparatus according to claim 5, wherein the at least one first connector portion is arranged on the main body so that the position of the electronic device attached thereto is desirable for the user of the electronic apparatus.

7. An apparatus according to claim 5, wherein the electronic apparatus is a display apparatus.

8. An apparatus according to claim 7, wherein the main body includes a display screen and a supporting member for supporting the display screen, the first connector portion being integrally mounted in the supporting member.

9. An apparatus according to claim 7, wherein the at least one first connector portion is arranged on the main body so that the position of the electronic device attached thereto is desirable for the user of the display apparatus.

10. An apparatus according to claim 9, wherein the position desirable for the user is a position in which the electronic device faces the user.

11. An apparatus according to claim 7, wherein the electronic device includes two elements as one set, and the electronic apparatus includes at least two first connector portions, the first connector portions being arranged so that the two elements of the electronic device are disposed at balanced positions on the left and right sides of the display apparatus with respect to the user.

12. An apparatus according to claim 1, wherein the circuit and the at least one first connector portion are formed on the basis of the USB specification.

13. An external apparatus, comprising:
an electronic apparatus having a main body, a circuit in the main body functioning as a hub, and at least one first connector portion electrically connected to the circuit;
an electronic device connected to the electronic apparatus; and
a computer connected to the electronic apparatus via the circuit for transmitting information to and receiving information from the electronic device.

14. An apparatus according to claim 13, wherein the electronic apparatus is a display apparatus.

15. An apparatus according to claim 13, wherein the electronic device has a second connector portion directly fixed thereto and the at least one first connector portion is integrally formed in the main body, the second connector portion being connected to the at least one first connector portion to directly attach the electronic device to the main body.

16. An apparatus according to claim 15, wherein the at least one first connector portion is arranged on the main body so that the position of the electronic device attached thereto is desirable for the user of the electronic apparatus.

17. An apparatus according to claim 13, wherein the circuit and the at least one first connector portion are formed on the basis of the USB specification.

18. An electronic device capable of being attached to an electronic apparatus having a main body, a circuit in the main body functioning as a hub, and at least one first connector portion integrally formed in the main body and electrically connected to the circuit, the electronic device comprising:
a body;
an operating portion in the body; and
a second connector portion integrally fixed to the body and adapted for connection to the at least one first connector portion,
wherein the electronic device can be directly attached to the main body of the electronic apparatus and can transmit information to or receive information from a computer connected to the electronic apparatus through the circuit.

19. A device according to claim 18, wherein the circuit, the at least one first connector portion and the second connector portion are formed on the basis of the USB specification.
